(19) United States
(12) Patent Application Publication
(10) Pub. No.: US 2009/0007171 A1
(43) Pub. Date: Jan. 1, 2009

(54) DYNAMIC INTERACTIVE ADVERTISEMENT INSERTION INTO CONTENT STREAM DELIVERED THROUGH IP NETWORK

(75) Inventors: Steven M. Casey, Littleton, CO (US); Gnanasegeran Selvadurai, Lafayette, CO (US); Felipe Castro, Erie, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Qwest Communications International Inc., Denver, CO (US)

(21) Appl. No.: 12/147,674

(22) Filed: Jun. 27, 2008

Related U.S. Application Data
(63) Continuation-in-part of application No. 11/291,274, filed on Nov. 30, 2005.

(51) Int. Cl. H04N 7/025; H04N 7/10; G06Q 30/00

(52) U.S. Cl. 725/34; 725/32; 725/35; 705/14; 709/217

(57) ABSTRACT

Tools are provided for supporting dynamic insertion of advertisements into a content stream delivered to a viewer through an Internet Protocol (“IP”) network. A viewer profile that includes at least one item of interest and an advertisement profile that includes a mapping from one or more items to at least one advertisement are maintained. An item in the viewer profile is matched to one or more advertisements based on the advertisement profile. The content stream is retrieved and an advertisement slot into which an advertisement should be inserted is identified. The advertisement to be inserted is selected from the one or more advertisements and the content of the advertisement is inserted into the advertisement slot in the content stream. A video component of the content stream with the content of the advertisement inserted is displayed on a display device.

### CROSS-REFERENCE TO RELATED APPLICATIONS

The present disclosure may be related to the following commonly assigned applications/patents of which the entire disclosure of each is incorporated herein by reference: U.S. patent application Ser. No. ______, filed on a date even herewith by Casey et al. and entitled “CONTENT SYNDICATION TO SET TOP BOX THROUGH IP NETWORK” (attorney docket no. 020366-100100US); U.S. patent application Ser. No. ______, filed on a date even herewith by Casey et al. and entitled “SYSTEM AND METHOD FOR SUPPORTING MESSAGING USING A SET TOP BOX” (attorney docket no. 020366-100200US); and U.S. patent application Ser. No. 12/061,046, filed on Apr. 2, 2008 by Casey et al. and entitled “IPTV FOLLOW ME CONTENT SYSTEM AND METHOD” (attorney docket no. 020366-100300US).

This application is a continuation-in-part of co-pending U.S. patent application Ser. No. 11/291,274 filed Nov. 30, 2005 entitled “REAL-TIME ON DEMAND SERVER,” which is hereby incorporated by reference, as if set forth in full in this document, for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to advertisement distribution, and more particularly, to inserting advertisements into a content stream delivered to a viewer.

### BACKGROUND

Existing television advertisement systems allow an advertisement to be distributed by inserting the advertisement at a marked advertisement slot in a content stream. For example, a head-end/server might identify markers in a data stream of a video program, and insert a data stream of an advertisement into an advertisement slot indicated by the markers. The data stream that includes both the video program and the advertisement is then distributed to a set top box. However, the same advertisement is distributed to all viewers of the content stream even though some viewers may have no interest in an item being advertised.

Additionally, the advertisement is often inserted into the content stream based on an overall profile of all viewers of the content stream. As a result, an advertiser is often forced to take an inefficient shotgun approach without being able to target specific viewers. For example, an advertiser might be aware that a portion of those in a particular age group is likely to be interested in an item offered by the advertiser. Consequently, the advertiser might have to purchase an advertisement slot of a video program simply because the video program is popular with viewers of the particular age group, even though viewers of the particular age group only constitute a portion of all viewers, and those who might actually be interested constitute an even smaller portion.

Moreover, even if a viewer could be allowed to specify a viewing preference, the viewer still would be unable to specify particular items of interest. For example, if a viewer could specify an interest in cooking or watching cooking shows, the viewer still would be unable to specify a particular kitchen accessory that the viewer is interested in buying. Accordingly, even if a content stream could be delivered on a per-viewer basis in accordance with a viewing preference, an advertiser still would be unable to target viewers who are interested in purchasing a particular item.

Hence, there is a need for improved advertisement distribution in inserting advertisements into a content stream.

### BRIEF SUMMARY

Embodiments provide novel tools (including, without limitation, systems, methods and software) for advertisement distribution. In one aspect, some embodiments maintain a viewer profile and provide a user interface for a viewer (i.e., a user) to interactively modify the viewer profile with at least one item of interest. In another aspect, tools in accordance with certain embodiments maintain an advertisement profile and provide an advertisement interface for an advertiser to interactively modify the advertisement profile with a mapping from one or more items to at least one advertisement. Beneficially, such embodiments enable an advertisement that relates to at least one item of interest to be dynamically distributed to the viewer based on the viewer profile and the advertisement profile. Accordingly, an advertiser is able to dynamically target an advertisement to viewers who are interested in purchasing a particular item.

Merely by way of example, in accordance with one set of embodiments, a viewer interactively modifies a viewer profile with at least one item of interest. In one embodiment, the at least one item of interest might be, for example, a Ford Explorer™. The at least one item of interest is matched to at least one item in an advertisement profile that includes a mapping from one or more items to one or more advertisements. Accordingly, a mapping might be from a Ford Explorer™ to an advertisement for a Ford Explorer™ and an advertisement for a Ford Expedition™. Consequently, the at least one item of interest is mapped to one or more advertisements. In this embodiment, the Ford Explorer™ might be mapped to an advertisement for a Ford Explorer™ and an advertisement for a Ford Expedition™. An advertisement is selected from the one or more advertisements, and the content of the advertisement is inserted into a marked advertisement slot in a content stream. The advertisement thus can be dynamically distributed to the viewer along with the content stream.

Optionally, certain embodiments might provide a user interface for modifying lists by which items are sorted and/or grouped. Certain embodiments might also provide a user interface for a viewer to schedule an event if the viewer is expected to be interested in purchasing an item at a later time. Likewise, certain embodiments might provide an advertisement interface for an advertiser to schedule an event if an item is expected to become available for sale at a later time.

The tools provided by various embodiments of the invention include, without limitation, methods, systems, and/or software products. Mainly by way of example, a method might comprise one or more procedures, any or all of which are executed by a computer system. Correspondingly, an embodiment might comprise a computer system configured with instructions to perform one or more procedures in accordance with methods provided by various embodiments. Similarly, a computer program might comprise a set of instructions that are executable by a computer system (and/or a processor therein) to perform such operations. In many cases, such software programs are encoded on physical and/or tangible computer readable media (such as, merely by way of example, optical media, magnetic media, and/or the like).

In one set of embodiments, a method of supporting dynamic insertion of advertisements into a content stream delivered to a viewer through an Internet Protocol (“IP”) network. The method might include maintaining a viewer profile that comprises at least one item of interest. The method might also include maintaining an advertisement profile that comprises a mapping from one or more items to at least one advertisement. The method might further include matching, based on the advertisement profile, an item in the viewer profile to one or more advertisements.

Additionally, the method might include retrieving the content stream, and/or identifying, in the content stream, an advertisement slot into which an advertisement should be inserted. The method might then include selecting the advertisement from the one or more advertisements, and/or retrieving a content of the advertisement. The method might include inserting the content of the advertisement into the advertisement slot in the content stream. Moreover, the method might include displaying a video component of the content stream with the content of the advertisement inserted on a display device. The viewer profile might include a list of pre-sale items that the viewer is interested in purchasing, a list of post-sale items that the viewer has already purchased, and/or a list of interested items that are related to the list of post-sale items and that the viewer may be interested in purchasing.

Moreover, the mapping from one or more items to at least one advertisement might include a geographic location, and matching an item in the viewer profile to one or more advertisements might also be based on the geographic location and a location of the viewer. Additionally, an advertiser might be provided an advertisement interface to modify the advertisement profile and the content of the advertisement through the IP network. Furthermore, selecting the advertisement from the one or more advertisements might be based on a length of the advertisement slot. Selecting the advertisement might also be based on how much an advertiser is willing to pay for having the advertisement inserted into the content stream, and the advertisement profile might include a price that the advertiser is willing to pay for having the advertisement inserted into the content stream; and/or a type of the content stream.

Furthermore, the content of the advertisement might be retrieved from a local storage device without passing through the IP network. Additionally, the content of the advertisement could be retrieved from a remote storage device through the IP network, based on a list of interested advertisements prior to retrieving the content stream, and/or the list of interested advertisements might be produced by matching items in the viewer profile to the advertisement profile. Moreover, the list of pre-sale items might be modified automatically based on a viewing behavior of the viewer, the viewer profile, and a knowledge base; and the knowledge base might be built by aggregating and correlating overall viewing behaviors and viewer profiles.

In another set of embodiments, a method of supporting dynamic insertion of advertisements into a content stream delivered to a viewer through an Internet Protocol (“IP”) network might include maintaining a viewer profile that comprises at least one item of interest and an advertisement profile that comprises a mapping from one or more items to at least one advertisement. The method might also include matching, based on the advertisement profile, an item in the viewer profile to one or more advertisements. Additionally, the method might include retrieving the content stream and identifying an advertisement slot into which an advertisement should be inserted. Moreover, the method might include selecting the advertisement from the one or more advertisements, retrieving a content of the advertisement, and inserting the content of the advertisement into the advertisement slot in the content stream. Furthermore, the method might include causing a video component of the content stream to be displayed on a display device.

In yet another set of embodiments, a device for receiving syndicated feed might comprise a processor and a computer readable medium in communication with the processor. In an aspect, the computer readable medium might have encoded thereon a set of instructions executable by the device to perform one or more operations. Merely by way of example, in some embodiments, the set of instructions might include instructions for maintaining a viewer profile that comprises at least one item of interest; instructions for maintaining an advertisement profile that comprises a mapping from one or more items to at least one advertisement; instructions for matching, based on the advertisement profile, an item in the viewer profile to one or more advertisements; instructions for retrieving the content stream; instructions for identifying, in the content stream, an advertisement slot into which an advertisement should be inserted; instructions for selecting the advertisement from the one or more advertisements; instructions for retrieving a content of the advertisement; instructions for inserting the content of the advertisement into the advertisement slot in the content stream; and/or instructions for causing a video component of the content stream to be displayed on a display device. In some embodiments, such a device might be incorporated within a larger distribution system, which might further include the display device and/or a storage device.

### BRIEF DESCRIPTION OF THE DRAWINGS

A further understanding of the nature and advantages of particular embodiments may be realized by reference to the remaining portions of the specification and the drawings wherein like reference numerals are used throughout the several drawings to refer to similar components. In some instances, a sublabel is associated with a reference numeral to denote one of multiple similar components. When reference is made to a reference numeral without specification to an existing sublabel, it is intended to refer to all such multiple similar components.

FIG. 1 is a block diagram illustrating a system for distributing advertisements, in accordance with various embodiments of the invention.

FIG. 2 is a process flow diagram illustrating a method of inserting advertisements into a content stream delivered to a viewer through an IP network, in accordance with various embodiments of the invention.

FIG. 3 is a generalized schematic diagram illustrating a computer system, in accordance with various embodiments of the invention.

FIG. 4 is a block diagram illustrating a networked system of computers, which can be used in accordance with various embodiments of the invention.

### DETAILED DESCRIPTION

While various aspects and features of certain embodiments have been summarized above, the following detailed description illustrates a few exemplary embodiments in further detail to enable one of skill in the art to practice such embodiments. In the following description, for the purposes of explanation, numerous specific details are set forth in order to provide a thorough understanding of the described embodiments. It will be apparent, however, to one skilled in the art that other embodiments of the present invention may be practiced without some of these specific details. In other instances, well-known structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In an aspect, certain embodiments of the invention include tools for advertisement distribution. Advantageously, using such embodiments of the invention, an advertisement that is of interest to a viewer can be dynamically inserted into a content stream. As used herein, the term “content stream” broadly describes a data stream of video, audio, video and audio, and/or other multimedia content. For instance, a viewer might be viewing a sports broadcasting and has modified a viewer profile to specify an interest in 4×4 trucks. An advertiser might have interactively modified an advertisement profile to specify a mapping from 4×4 trucks to an advertisement for a Ford Expedition™. Additionally, the advertiser might have also interactively modified the advertisement profile with a mapping from 4×4 trucks or a Ford Expedition™ to an advertisement of special incentives for buying a Ford Expedition™ at the time. Accordingly, the viewer might be matched with advertisements for both a Ford Expedition™ and special incentives for buying one. The content of either or both advertisements is then retrieved and dynamically inserted into the sports broadcasting being viewed by the viewer.

In another aspect of some embodiments, a viewer can interactively modify lists by which items are sorted and/or grouped. Such lists might include, without limitation, pre-sale items that the viewer has not purchased, post-sale items that the viewer has already purchased, and interested items that relate to the post-sale items and that the viewer might also be interested in purchasing. For instance, after the viewer has purchased a Ford Expedition™, the viewer might be interested in purchasing mud guards or a cargo liner for the Ford Expedition™. In yet another aspect of certain embodiments, a viewer can interactively specify an event. For example, the viewer might be interested in having the Ford Expedition's™ oil changed after three months.

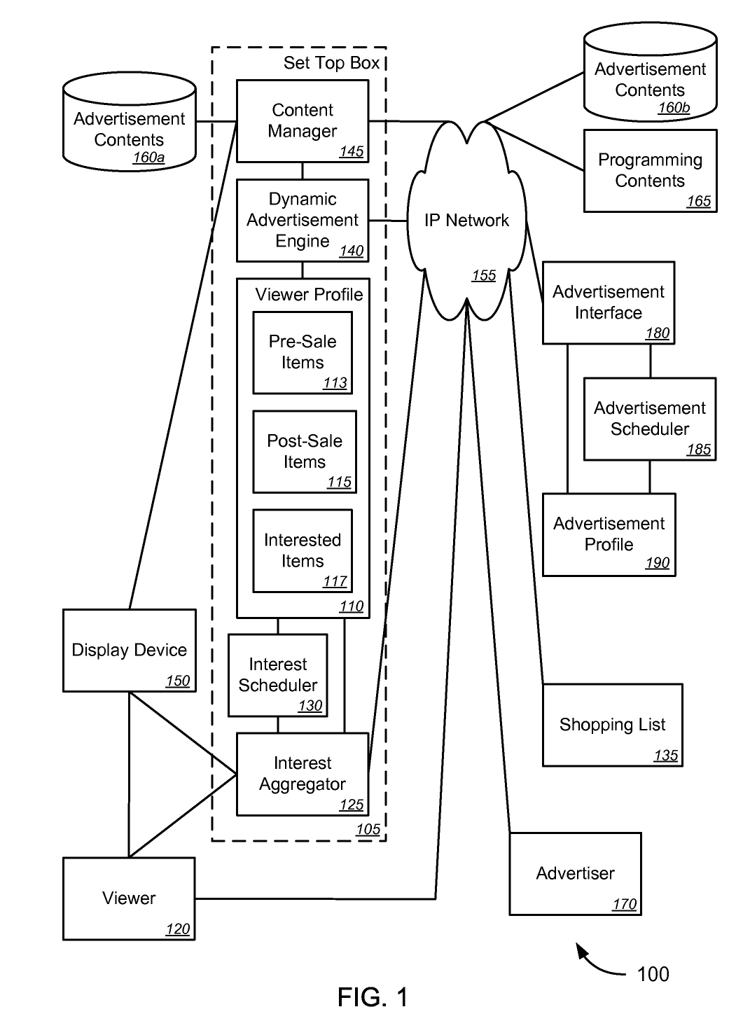

FIG. 1 illustrates an exemplary system 100 for distributing advertisements. It should be noted that, for descriptive purposes, the illustrated system 100 includes various elements that may not be included in certain embodiments of the invention. A set top box 105 comprises a viewer profile 110, an interest aggregator 125, an interest scheduler 130, a dynamic advertisement engine 140, and a content manager 145. The viewer profile 110 comprises pre-sale items 113, post-sale items 115, and interested items 117. A viewer 120 has access to the interest aggregator 125, a display device 150, and an IP network 155. The interest aggregator 125 updates the viewer profile 110 either directly or through the interest scheduler 130. Additionally, the interest aggregator 125 publishes a shopping list 135 on the IP network 155 and provides the viewer 120 access to the viewer profile 110 through the IP network 155.

The dynamic advertisement engine 140 has access to the IP network 155 and the viewer profile 110. The dynamic advertisement engine 140 can access an advertisement profile 190 through an advertisement interface 180 over the IP network 155. The content manager 145 retrieves a content stream from programming contents 165 to be displayed on the display device 150 and has access to the dynamic advertisement engine 140, a first set of advertisement contents 160a that is stored locally, and the IP network 155. Through the IP network 155, the content manager 145 can access a second set of advertisement contents 160b and the programming contents 165. These elements are described in greater detail as follows.

In an aspect, the viewer profile 110 comprises at least one list of items. In some embodiments, the viewer profile 110 might comprise a list of pre-sale items 113 that the viewer 120 is interested in purchasing. For example, some items in the list of pre-sale items 113 might be 4×4 trucks and/or a Ford Expedition™. The viewer profile 110 might also comprise a list of post-sale items 115 that the viewer 120 has already purchased. For instance, the viewer 120 might have purchased a Ford Expedition™ and the list of post-sale items 115 might include a Ford Expedition™. Additionally, the viewer profile 110 might comprise a list of interested items 117 that relate to items in the post-sale items 115 and that the viewer 120 might also be interested in purchasing. For example, the viewer 120 might also be interested in purchasing a cargo liner for the Ford Expedition™. The viewer profile 110 might be stored in a database that resides on a storage device in an embodiment.

The interest aggregator 125 might accept an input from the viewer 120 to modify the viewer profile 110 in some embodiments. In some embodiments, the interest aggregator 125 might also accept an input from the viewer 120 to schedule an event with the interest scheduler 130. Additionally, the interest aggregator 125 might analyze other input from the viewer 120, for example selections of content streams by the viewer 120, to determine a viewing behavior of the viewer 120. The viewing behavior might be used to determine how to automatically modify the viewer profile 110 in some embodiments. The input might be accepted through a user interface that is provided to the viewer. The user interface might comprise menus, windows, dialog boxes, and/or input or display fields.

In some embodiments, the viewer 120 might be configured to interact with the interest aggregator 125 through a user interface provided via a Walled Garden. In this case, the term “Walled Garden” refers to a closed environment comprising services provided specifically to the viewer 120; the environment is not open to the general public. This closed environment might be displayed on the display device 150 locally without passing through any network. Accordingly, the user interface might include the display device 150 including a television set and/or various input devices including a remote control, and/or a remote keyboard. The viewer 120 might also be able to interact with the interest aggregator 125 through a user interface provided via a web based service available on the IP network 155 in some embodiments. In such embodiments, the web based service might be based on typical World Wide Web standards including HTTP and HTML text and/or tools including Adobe Flash and/or techniques including AJAX. It is understood by those skilled in the art that the viewer 120 might access such a web based service by using a web client/browser running on a computer having its own display device and input devices.

As noted above, in some embodiments, the interest aggregator 125 schedules an event with the interest scheduler 130. Once the event is triggered at the interest scheduler 130, the interest scheduler 130 modifies the viewer profile 110 with an item that is associated with the event. For example, the viewer 120 might specify that a Ford Expedition™ needs to have its oil changed in three months. Accordingly, the interest aggregator 125 could be configured to schedule an event with the interest scheduler 130 so that after three months, when the event is triggered, the interest scheduler 130 would finally modify the viewer profile 110 to include oil change as an item that the viewer 120 is interested in purchasing.

In some embodiments, the interest aggregator 125 also publishes a portion of the viewer profile 110 on the IP network 155 as the shopping list 135, with the viewer 120 being able to control which portion to publish and which portion not to publish. The shopping list 135 might then be accessed by other viewers or advertisers. For example, another viewer might be interested in buying the viewer 120 a gift based on the shopping list 135. An advertiser might also provide services or products and/or create advertisements according to the shopping list 135. In one embodiment, the shopping list 135 might be sent to an Internet server on the IP network 155, and the shopping list 135 is subsequently provided by the Internet server publicly via a web interface. In another embodiment, the shopping list 135 might be provided directly by the set top box 105 via a network service/protocol that is accessible or understood only by customers of the content distributor (i.e., the shopping list 135 is proprietary or private to customers of a provider of this embodiment).

In the system 100, the dynamic advertisement engine 140 is responsible for producing a list of interested advertisements by dynamically matching an item in the viewer profile 110 to one or more advertisements based on a mapping in the advertisement profile 190. In some embodiments, the dynamic advertisement engine 140 might attempt to match each item in the list of pre-sale items 113 and the list of interested items 117 to one or more advertisements. Accordingly, over the IP network 155 and through the advertisement interface 180, the dynamic advertisement engine 140 might access the advertisement profile 190 that comprises a mapping from one or more items to at least one advertisement. It should be noted that, in some cases, this access might be authenticated (for example, by requiring secure login at the advertisement interface 180), while in other cases such authentication might be omitted, because the dynamic advertisement engine 140 does not modify the advertisement profile 190. In some embodiments, the dynamic advertisement engine 140 might also save the advertisement profile 190 in a local storage device that is refreshed periodically. In such embodiments, the amount of network access is drastically reduced because the dynamic advertisement engine 140 does not need to repeatedly access the advertisement profile 190 over the IP network 155.

Accordingly, the dynamic advertisement engine 140 produces a list of interested advertisements that can be accessed by the content manager 145. The content manager 145 is responsible for inserting interested advertisements into a content stream and/or causing the content stream to be displayed on the display device 150. In some embodiments, the content manager 145 might retrieve the content stream from the programming contents 165 through the IP network 155. The programming contents 165 might be received and/or retrieved from a server that provides the content stream, for example a sports broadcast, a television program, etc., to the content manager 145. Alternatively, in some embodiments, the content manager 145 might retrieve the content stream from a local storage device. A duration of advertisement might comprise from 0 to 33 percent, 34 to 66 percent, or 67 to 100 percent of a duration of the overall content stream in various embodiments. Other ranges might be possible, including from 17 to 50 percent or from 51 to 84 percent. As can be appreciated by those skilled in the art, when the duration of advertisement is close to 100 percent, the content stream in fact functions very much like a home shopping channel that is based on the viewer's interest. The content manager 145 then identifies, in the content stream, an advertisement slot into which an advertisement should be inserted. Subsequently, the content manager 145 selects an advertisement from the list of interested advertisements produced by the dynamic advertisement engine 140 and/or retrieves the content of the advertisement.

In certain embodiments, the content manager 145 might retrieve the content of the selected advertisement either from the locally stored advertisement contents 160a or from the remotely stored advertisement contents 160b. The locally stored advertisement contents 160a might reside on a storage device that is local to the set top box 105 so that the retrieval is without passing through any network. The storage device might be external to the set top box 105 in one embodiment, and internal to the set top box 105 in another embodiment; in some cases, a combination of external and internal storage may be used. The remotely stored advertisement contents 160b might reside on a remote storage device that is connected to an Internet server, and the remotely stored advertisement contents 160b therefore might be provided through the Internet server. Subsequently, the content manager 145 is able to retrieve and/or dynamically insert the advertisement content into the content stream that is displayed on the display device 150.

In some embodiments, the interest aggregator might provide a user interface for the viewer 120 to respond to an advertisement through a service available on the IP network 155. For instance, returning to the example above, the viewer 120 might be interested in scheduling a maintenance appointment over the IP network 155 with a Ford™ dealer after viewing an advertisement of scheduled maintenance for the viewer's Ford Expedition™. Likewise, after viewing an advertisement of mud guards, the viewer 120 might be interested in placing an order to purchase the mud guards with the advertiser 170. Accordingly, the viewer 120 might press a button on a remote control to bring up the user interface in some embodiments. In some instances, the user interface might cause phone call (such as a voice over IP phone call, for example) to be initiated to the Ford™ dealer. In another instance, the user interface might bring up a web client/browser that communicates with an Internet server of the advertiser 170.

The advertiser 170 might be able to interactively modify the advertisement profile 190 through the advertisement interface 180 that is provided over the IP network 155 in some embodiments. In such embodiments, this ability gives the advertiser 170 greater control and/or saves the content distributor from having to reenter mappings specified by the advertiser 170. To prevent unauthorized modification to the advertisement profile 190, in some embodiments, the advertisement interface 180 might require authentication before the advertiser 170 is allowed to modify the advertisement profile 190. The advertisement scheduler 185 allows the advertiser 170 to schedule an event through the advertisement interface 180 if an item is expected to become available for sale at a later time.

The advertisement interface 180, the advertisement scheduler 185, and the advertisement profile 190 might all be implemented as part of an Internet server in some embodiments. Besides the advertisement profile, an interface other than the advertisement interface 180 might be provided for the advertiser 170 to interactively modify the remotely stored advertisement contents 160b in one embodiment. In another embodiment, the advertisement interface 180 and the advertisement scheduler 185 might provide access to the remotely stored advertisement contents 160b. Accordingly, in such embodiment, the advertiser 170 might be able to modify both the advertisement profile 190 and any associated advertisement contents 160b at a same time through the common advertisement interface 180.

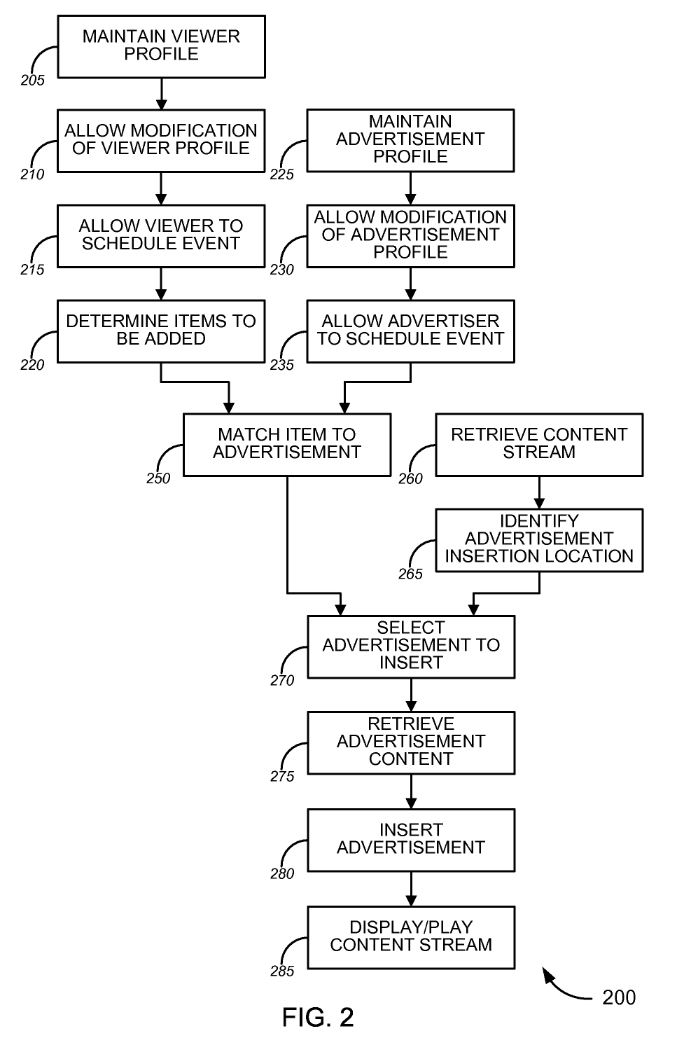

FIG. 2 illustrates a method 200 of inserting advertisements into a content stream delivered to a viewer through an IP network, in accordance with certain embodiments of the invention. In some cases, the method 200 can be implemented by a system, for example the system 100 described above. It should be appreciated, however, that the system 100 of FIG. 1 may operate in a manner different than the method of FIG. 2; likewise, it should be understood that the method 200 of FIG. 2 may be implemented using any type of system and therefore is not limited to implementation in the system 100 of FIG. 1 (or any particular structural arrangement, for that matter).

In some embodiments, the method 200 comprises maintaining a viewer profile (block 205), which can include, without limitation, storing the viewer profile at a storage device. As noted above, in certain embodiments, the viewer profile might be stored as three lists of items: pre-sale items, post-sale items, and interested items. The method might further comprise providing a user interface to allow interactive modification of the viewer profile (block 210) in some embodiments. For example, the viewer might be provided a user interface to interactively add, update, or delete items in the list of pre-sale items, post-sale items, and interested items. The user interface might be provided through a Walled Garden and/or a web based interface in certain embodiments, as noted above. The viewer might also be provided a user interface to schedule an event (block 215) as a way to modify the viewer profile. The viewer profile is then modified with an item that is associated with the event when the event is triggered.

Additionally, the viewer profile might be modified automatically based on determinations made at block 220. In certain embodiments, as noted above, the interest aggregator might analyze selections of content streams by the viewer in order to determine how to modify the viewer profile based on a viewing behavior of the viewer. For example, if the viewer regularly watches HGTV™ (Home & Garden Television™), the interest aggregator might add kitchen appliances as a pre-sale item to the list of pre-sale items. In some embodiments, this might be determined based on a knowledge base that is built using survey results. In other embodiments, rather than using survey results, this knowledge base might be built according to an aggregation and/or correlation of overall viewing behaviors and viewer profiles. For example, if seventy percent of all viewers who often watch Iron Chef™, a Japanese culinary game show, have a santoku knife in their viewer profiles, and the present viewer likes to watch Iron Chef™ as well, the interest aggregator might add a santoku knife to the present viewer's viewer profile. As will be appreciated by those of skill in the art, such knowledge base might be more readily built at a centralized server of the content distributor rather than individually at each set top box. The knowledge base is then distributed to be used by the interest aggregator of each set top box.

In certain embodiments, as noted above, the interest aggregator might publish a portion of the viewer profile on the IP network. Consequently, in some embodiments, the interest aggregator might be able to use another viewer's shopping list to automatically modify the present viewer's viewer profile. For example, another viewer might have specified a cargo liner as an interested item when a Ford Expedition™ is in that viewer's list of post-sale items. Accordingly, the interest aggregator might add a cargo liner to the present viewer's list of interested items if the present viewer has also specified a Ford Expedition™ in the list of post-sale items. As will be appreciated by those skilled in the art, such features might be more easily and/or accurately implemented in some embodiments if a relationship between an item in the list of post-sale items and an item in the list of interested items is also specified in the viewer profile and published in the shopping list. For example, this makes it easier to determine that a cargo liner in the list of interested items in fact relates to a Ford Expedition™ in the list of post-sale items.

In some embodiments, the method 200 also comprises maintaining an advertisement profile (block 225), for example by storing the advertisement profile at a storage device. The method might further comprise providing an advertisement interface for an advertiser to interactively modify the advertisement profile (block 230). For example, the advertiser might be able to interactively add, update, or delete mappings in the advertisement profile through a website. Additionally, at block 235, the advertiser might be provided an advertisement interface to schedule an event, for example if a product or service is expected to become available for sale at a later time. The advertisement profile is then modified with a mapping that is associated with the event when the event is triggered.

In some embodiments, maintaining an advertisement profile at block 225 might include updating the advertisement profile with advertisements from an advertising network. An advertisement network refers to a collection of advertisements generally to be provided on the Internet. In some instances, an advertisement network might comprise a private network, e.g., not targeted to the general public. The advertisements might include banner ads and rich media. However, it will be understood that more traditional advertisements can be adapted for display at a set top box. In one instance, software might be set up to automatically transfer advertisements, especially those that are already associated with keywords, from one or more advertisement networks. In another instance, a human operator might select and transfer advertisements especially for those advertisements that are not readily associated with keywords (e.g., certain advertisements from an affiliate program).

At block 250, an item in the viewer profile is dynamically matched to one or more advertisements based on a mapping in the advertisement profile, in order to produce a list of interested advertisements. As noted above, in certain embodiments, the advertisement profile might be retrieved over the IP network or from a local storage device. In such embodiments, the matching might be repeated for various lists of items in the viewer profile, with each item being mapped to one or more advertisements based on the retrieved advertisement profile. Consequently, the list of interested advertisements is produced. Also as noted above, the mapping in the advertisement profile might be from one or more items to at least one advertisement. Additionally, because some advertisements are specific to a geographic location, the mapping might further comprise a geographic location in some embodiments. In such embodiments, the geographic location might be a country, a region in a country, a state, a city, or any other type of geographic specification. For example, an auto shop might specify a mapping from both oil change and southeast Denver to the auto shop's oil change advertisement. Accordingly, a viewer who resides in southeast Denver and has specified oil change in the viewer's viewer profile might be matched to the auto shop's oil change advertisement. Conversely, another viewer who has also specified oil change in the viewer's viewer profile but resides in north Denver would not be matched to the auto shop's oil change advertisement. As will be appreciated by those of skill in the art, in certain embodiments, the geographic location of the viewer might be determined based on, without limitation, an IP address assigned to the viewer's device/set top box, the viewer's registration information with the content distributor, and/or an entry in the viewer profile.

In some embodiments, if an adequate number of interested advertisements cannot be produced as a result of matching using the advertisement profile, one or more advertisement networks might be consulted. In other embodiments, one or more advertisement networks might be consulted instead of or in addition to matching using the advertisement profile. As noted above, the advertisement profile might be updated with certain advertisements from one or more advertisement networks. However, the advertisement networks might include many more advertisements that have not been transferred to the advertisement profile. It will also be understood that certain advertisement networks offer an agent (e.g., via a link and/or software) that matches certain characteristics of a web page with advertisements from the respective advertisement network. Accordingly, in some embodiments, one or more of these agents might be adapted to take the viewer profile into consideration. In one instance, a web page might be generated based on the viewer profile, and one or more of these agents might analyze the generated web page so as to match advertisements. In other embodiments, the dynamic advertisement agent might send a query to at least one advertisement network. The query might include a set of keywords. The at least one advertisement network might respond with a list of advertisements.

At block 260, the content manager retrieves a content stream to be displayed. As noted above, a source of the content stream might be available over the IP network or from a local storage device. Accordingly, in some cases, the content stream might be retrieved through an Ethernet network. In other cases, the content stream might be retrieved through a Universal Serial Bus (“USB”) or a Serial Advanced Technology Attachment (“SATA”) interface. In yet other cases, other techniques might be used. The content manager then identifies, in the content stream, an advertisement slot into which an advertisement should be inserted at block 265. In some embodiments, this identification might be performed by searching for special marks in the content stream. After having identified an advertisement slot into which an advertisement should be inserted at block 265 and having obtained a list of interested advertisements at block 250, one of the interested advertisements is selected for insertion at block 270.

The content manager might initially make the selection based on a length of the advertisement slot in some embodiments. Advertisement slots vary in length. For example, a home shopping channel that is based on the viewer's interest as mentioned above might comprise several 30 minute advertisement slots, several 15 second slots, and/or several 30 second slots. Accordingly, if the advertisement slot is a 15 second slot, advertisements that are 15 seconds in length might be initially selected from the list of interested advertisements. In some embodiments, a criteria for making the selection might also be how much an advertiser is willing to pay for having an advertisement inserted into the content stream; the higher the price, the more likely the advertisement will be inserted. As will be appreciated by those of skill in the art, in such embodiments, the advertisement profile might further comprise a price that an advertiser is willing to pay for having an advertisement inserted. Each time that an advertisement has been inserted, the content manager might also report to the content distributor and/or record locally for aggregated reporting at a later time. In some embodiments, criteria for making the selection might also include how recent and/or how frequent the viewer has seen the advertisement. For example, if the viewer has just seen the advertisement, the advertisement might be selected right away. In other embodiments, the selection might also be based on a type of the content stream. For example, if the viewer is watching a cooking show and the viewer is interested in buying a particular kitchen accessory and a Ford Explorer™, an advertisement about the particular kitchen accessory might be selected first.

It will be understood that revenues earned from an advertisement might be based on an actual response (e.g., pressing a button on a remote control to “click” on the advertisement) instead of and/or in addition to having the advertisement inserted/displayed. Accordingly, in some embodiments, criteria for making the selection might include a measurement of advertisement performance. In one instance, advertisement performance might be defined as a number of times that an advertisement has been responded to out of a total number of times that the advertisement has been displayed. These two components for determining the measurement of advertisement performance for each advertisement might be stored initially at each set top box. A centralized server might collect the two components for each advertisement from multiple set top boxes, so that an overall measurement of advertisement performance for each advertisement might be determined. Accordingly, the advertisement profile might further comprise advertisement performance information that is constantly updated by the centralized server for each advertisement. In some embodiments, rather than having a centralized server making the determination, a set top box might update a centralized database to indicate a number of times that an advertisement has been displayed by the set top box, as well as a number of times that the advertisement has been responded to. This or another set top box might retrieve the two components from the centralized database to determine the measurement of advertisement performance for each advertisement. It will also be understood that revenues earned from an advertisement might be based on a resulting transaction instead of and/or in addition to an initial response. Hence, in some instances, advertisement performance might be defined as revenue realized/shared from a resulting transaction out of a total number of times that the advertisement has been displayed. Accordingly, it will be understood that in some embodiments, a centralized server and/or centralized database similar to those mentioned above might further interact with other systems where resulting transactions take place.

At block 275, the content manager retrieves a content of the selected advertisement. As noted above, a source of the retrieval might be the locally stored advertisement contents or the remotely stored advertisement contents. Accordingly, similar to retrieving the content stream, the retrieval might be through a SATA interface or an Ethernet network, and/or other techniques might also be used in certain embodiments. As will be appreciated by those skilled in the art, in some embodiments, the content manager might download particular advertisement contents from the remotely stored advertisement contents to the locally stored advertisement contents when there is low network usage. In such embodiments, the particular advertisement contents to download might be based on the list of interested advertisements produced by the dynamic advertisement engine even if the viewer is not watching a content stream at the time. In some embodiments, the content manager might also save advertisement content in the locally stored advertisement contents after the advertisement content has been downloaded over the IP network. In these embodiments, the content manager is then able to retrieve a content of a particular advertisement locally without having to download the particular advertisement content over the IP network if the particular advertisement is selected to be inserted at a later time. In some embodiments, the content of the selected advertisement might be provided by an advertisement network as noted above. In one instance, the content manager might retrieve the content from the advertisement network. In another instance, an agent provided by the advertisement network might perform the actual retrieval.

At block 280, the content of the selected advertisement is then inserted into the content stream at the advertisement slot identified at block 265. At block 285, a video component of the content stream with the advertisement content inserted is displayed on the display device. For example, in an embodiment, the set top box might send a video signal to a television, which causes the video component to be displayed on the television. If the content stream also includes an audio component, the audio component might be played and an audio signal might be sent to the television and/or speakers. It is noted that in some cases the content stream and the selected advertisement might include an audio component but not a video component. In these cases, it is the audio component of the content stream that is played at block 285. Accordingly, the advertisement that is of interest to the viewer is dynamically distributed to the viewer along with the content stream.

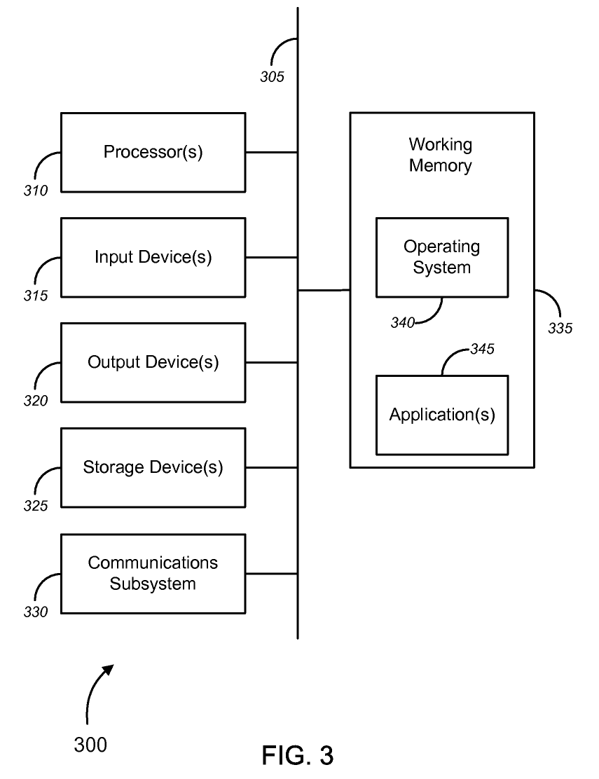

FIG. 3 provides a schematic illustration of one embodiment of a computer system 300 that can perform the methods provided by various other embodiments, as described herein, and/or can function as a head-end/server, an Internet server, a centralized server, or an embodiment of a set top box. It should be noted that FIG. 3 is meant only to provide a generalized illustration of various components, any or all of which may be utilized as appropriate. FIG. 3, therefore, broadly illustrates how individual system elements may be implemented in a relatively separated or relatively more integrated manner.

The computer system 300 is shown comprising hardware elements that can be electrically coupled via a bus 305 (or may otherwise be in communication, as appropriate). The hardware elements may include one or more processors 310, including without limitation one or more general-purpose processors and/or one or more special-purpose processors (such as digital signal processing chips, graphics acceleration processors, and/or the like); one or more input devices 315, which can include without limitation a mouse, a keyboard and/or the like; and one or more output devices 320, which can include without limitation a display device, a printer and/or the like.

The computer system 300 may further include (and/or be in communication with) one or more storage devices 325, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 300 might also include a communications subsystem 330, which can include without limitation a modem, a network card (wireless or wired), an infra-red communication device, a wireless communication device and/or chipset (such as a Bluetooth™ device, an 802.11 device, a WiFi device, a WiMax device, cellular communication facilities, etc.), and/or the like. The communications subsystem 330 may permit data to be exchanged with a network (such as the network described below, to name one example), other computer systems, and/or any other devices described herein. In many embodiments, the computer system 300 will further comprise a working memory 335, which can include a RAM or ROM device, as described above.

The computer system 300 also can comprise software elements, shown as being currently located within the working memory 335, including an operating system 340, device drivers, executable libraries, and/or other code, such as one or more application programs 345, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer readable storage medium, such as the storage device(s) 325 described above. In some cases, the storage medium might be incorporated within a computer system, such as the system 300. In other embodiments, the storage medium might be separate from a computer system (i.e., a removable medium, such as a compact disc, etc.), and or provided in an installation package, such that the storage medium can be used to program, configure and/or adapt a general purpose computer with the instructions/code stored thereon. These instructions might take the form of executable code, which is executable by the computer system 300 and/or might take the form of source and/or installable code, which, upon compilation and/or installation on the computer system 300 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 300) to perform methods in accordance with various embodiments of the invention. According to a set of embodiments, some or all of the procedures of such methods are performed by the computer system 300 in response to processor 310 executing one or more sequences of one or more instructions (which might be incorporated into the operating system 340 and/or other code, such as an application program 345) contained in the working memory 335. Such instructions may be read into the working memory 335 from another computer readable medium, such as one or more of the storage device(s) 325. Merely by way of example, execution of the sequences of instructions contained in the working memory 335 might cause the processor(s) 310 to perform one or more procedures of the methods described herein.

The terms “machine readable medium” and “computer readable medium,” as used herein, refer to any medium that participates in providing data that causes a machine to operation in a specific fashion. In an embodiment implemented using the computer system 300, various computer readable media might be involved in providing instructions/code to processor(s) 310 for execution and/or might be used to store and/or carry such instructions/code (e.g., as signals). In many implementations, a computer readable medium is a physical and/or tangible storage medium. Such a medium may take many forms, including but not limited to, non-volatile media, volatile media, and transmission media. Non-volatile media includes, for example, optical and/or magnetic disks, such as the storage device(s) 325. Volatile media includes, without limitation, dynamic memory, such as the working memory 335. Transmission media includes, without limitation, coaxial cables, copper wire and fiber optics, including the wires that comprise the bus 305, as well as the various components of the communication subsystem 330 (and/or the media by which the communications subsystem 330 provides communication with other devices). Hence, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 310 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 300. These signals, which might be in the form of electromagnetic signals, acoustic signals, optical signals and/or the like, are all examples of carrier waves on which instructions can be encoded, in accordance with various embodiments of the invention.

The communications subsystem 330 (and/or components thereof) generally will receive the signals, and the bus 305 then might carry the signals (and/or the data, instructions, etc. carried by the signals) to the working memory 335, from which the processor(s) 305 retrieves and executes the instructions. The instructions received by the working memory 335 may optionally be stored on a storage device 325 either before or after execution by the processor(s) 310.

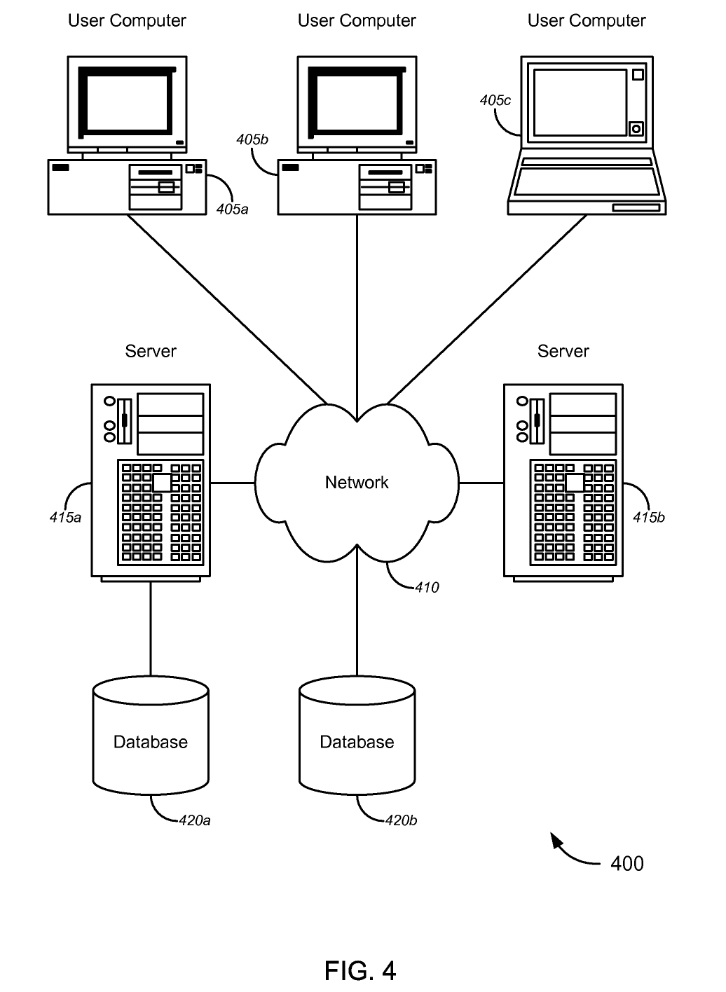

A set of embodiments comprises systems for supporting advertisement distribution. Merely by way of example, FIG. 4 illustrates a schematic diagram of a system 400 that can be used in accordance with one set of embodiments. The system 400 can include one or more user computers 405. The user computers 405 can be general purpose personal computers (including, merely by way of example, personal computers and/or laptop computers running any appropriate flavor of Microsoft Corp.'s Windows™ and/or Apple Inc.'s Macintosh™ operating systems) and/or workstation computers running any of a variety of commercially-available UNIX™ or UNIX-like operating systems. These user computers 405 can also have any of a variety of applications, including one or more applications configured to perform methods provided by various embodiments (as described above, for example), as well as one or more office applications, database client and/or server applications, and/or web browser applications. Alternatively, the user computers 405 can be any other electronic device, such as a thin-client computer, Internet-enabled mobile telephone, and/or personal digital assistant, capable of communicating via a network (e.g., the network 410 described below) and/or displaying and navigating web pages or other types of electronic documents. Although the exemplary system 400 is shown with three user computers 405, any number of user computers can be supported.

Certain embodiments of the invention operate in a networked environment, which can include a network 410. The network 410 can be any type of network familiar to those skilled in the art that can support data communications using any of a variety of commercially-available (and/or free or proprietary) protocols, including without limitation TCP/IP, SNA, IPX, AppleTalk, and the like. Merely by way of example, the network 410 can be a local area network (“LAN”), including without limitation an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 415. Each of the server computers 415 may be configured with an operating system, including without limitation any of those discussed above, as well as any commercially (or freely) available server operating systems. Each of the servers 415 may also be running one or more applications, which can be configured to provide services to one or more clients 405 and/or other servers 415.

Merely by way of example, one of the servers 415 may be a web server, which can be used, merely by way of example, to process requests for web pages or other electronic documents from user computers 405. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 405 to perform methods of the invention.

The server computers 415, in some embodiments, might include one or more application servers, which can be configured with one or more applications accessible by a client running on one or more of the client computers 405 and/or other servers 415. Merely by way of example, the server(s) 415 can be one or more general purpose computers capable of executing programs or scripts in response to the user computers 405 and/or other servers 415, including without limitation web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including without limitation those commercially available from Oracle, Microsoft, Sybase™, IBM™ and the like, which can process requests from clients (including, depending on the configuration, dedicated database clients, API clients, web browsers, etc.) running on a user computer 405 and/or another server 415. In some embodiments, an application server can create web pages dynamically for displaying the information in accordance with various embodiments, such as to provide a user interface for a viewer or to provider an advertisement interface for an advertiser. Data provided by an application server may be formatted as one or more web pages (comprising HTML, Javascript, etc., for example) and/or may be forwarded to a user computer 405 via a web server (as described above, for example). Similarly, a web server might receive web page requests and/or input data from a user computer 405 and/or forward the web page requests and/or input data to an application server. In some cases a web server may be integrated with an application server.

In accordance with further embodiments, one or more servers 415 can function as a file server and/or can include one or more of the files (e.g., application code, data files, etc.) necessary to implement various disclosed methods, incorporated by an application running on a user computer 405 and/or another server 415. Alternatively, as those skilled in the art will appreciate, a file server can include all necessary files, allowing such an application to be invoked remotely by a user computer 405 and/or server 415.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 420. The location of the database(s) 420 is discretionary: merely by way of example, a database 420a might reside on a storage medium local to (and/or resident in) a server 415a (and/or a user computer 405). Alternatively, a database 420b can be remote from any or all of the computers 405, 415, so long as it can be in communication (e.g., via the network 410) with one or more of these. In a particular set of embodiments, a database 420 can reside in a storage-area network (“SAN”) familiar to those skilled in the art. (Likewise, any necessary files for performing the functions attributed to the computers 405, 415 can be stored locally on the respective computer and/or remotely, as appropriate.) In one set of embodiments, the database 435 can be a relational database, such as an Oracle database, that is adapted to store, update, and retrieve data in response to SQL-formatted commands. The database might be controlled and/or maintained by a database server, as described above, for example.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while various functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method of supporting dynamic insertion of advertisements into a content stream delivered to a viewer through an Internet Protocol (“IP”) network, the method comprising:
maintaining a viewer profile that comprises at least one item of interest;
maintaining an advertisement profile that comprises a mapping from one or more items to at least one advertisement;
matching, based on the advertisement profile, an item in the viewer profile to one or more advertisements;
retrieving the content stream;
identifying, in the content stream, an advertisement slot into which an advertisement should be inserted;
selecting the advertisement from the one or more advertisements;
retrieving a content of the advertisement;
inserting the content of the advertisement into the advertisement slot in the content stream;
displaying a video component of the content stream with the content of the advertisement inserted on a display device;
wherein the viewer profile includes:
a list of pre-sale items that the viewer is interested in purchasing;
a list of post-sale items that the viewer has already purchased; and
a list of interested items that are related to the list of post-sale items and that the viewer may be interested in purchasing;
wherein the mapping from one or more items to at least one advertisement includes a geographic location, and wherein matching an item in the viewer profile to one or more advertisements is also based on the geographic location and a location of the viewer;
wherein an advertiser is provided an advertisement interface to modify the advertisement profile and the content of the advertisement through the IP network;
wherein selecting the advertisement from the one or more advertisements is based on:
a length of the advertisement slot;
how much an advertiser is willing to pay for having the advertisement inserted into the content stream, and wherein the advertisement profile includes a price that the advertiser is willing to pay for having the advertisement inserted into the content stream; and
a type of the content stream;
wherein the content of the advertisement is retrieved from a local storage device without passing through the IP network, and wherein:
the content of the advertisement was retrieved from a remote storage device through the IP network based on a list of interested advertisements prior to retrieving the content stream, and
the list of interested advertisements was produced by matching items in the viewer profile to the advertisement profile; and
wherein the list of pre-sale items is modified automatically based on a viewing behavior of the viewer, the viewer profile, and a knowledge base, and wherein the knowledge base is built by aggregating and correlating overall viewing behaviors and viewer profiles.

2. A method of supporting dynamic insertion of advertisements into a content stream delivered to a viewer through an Internet Protocol (“IP”) network, the method comprising:
maintaining a viewer profile that comprises at least one item of interest;
maintaining an advertisement profile that comprises a mapping from one or more items to at least one advertisement;
matching, based on the advertisement profile, an item in the viewer profile to one or more advertisements;
retrieving the content stream;
identifying, in the content stream, an advertisement slot into which an advertisement should be inserted;
selecting the advertisement from the one or more advertisements;
retrieving a content of the advertisement;
inserting the content of the advertisement into the advertisement slot in the content stream; and
causing a video component of the content stream with the content of the advertisement inserted to be displayed on a display device.

3. The method of claim 2, wherein the viewer profile comprises:
a list of pre-sale items that the viewer is interested in purchasing;
a list of post-sale items that the viewer has already purchased; and
a list of interested items that are related to the list of post-sale items and that the viewer may be interested in purchasing.

4. The method of claim 3, further comprising:
determining a pre-sale item to be added to the list of pre-sale items based on:
the viewer's viewing behavior of content streams.

5. The method of claim 3, further comprising:
providing a user interface for the viewer to modify the list of pre-sale items;
providing the user interface for the viewer to modify the list of post-sale items; and
providing the user interface for the viewer to modify the list of interested items.

6. The method of claim 5, wherein the user interface is provided via a Walled Garden.

7. The method of claim 5, wherein the user interface is provided via a service available on the IP network.

8. The method of claim 2, further comprising:
providing a user interface for the viewer to schedule an event and specify at least one item of interest; and
modifying, when the event is triggered, the viewer profile with the at least one item of interest.

9. The method of claim 3, further comprising:
publishing a portion of the viewer profile on the IP network.

10. The method of claim 9, further comprising:
determining items to be added to the list of interested items based on:
the list of post-sale items; and
another viewer's profile comprising post-sale items and interested items;
wherein a relationship between an item in the list of post-sale items and an item in the list of interested items is specified in the viewer profile; and
wherein the relationship is in the portion of the viewer profile published on the IP network.

11. The method of claim 2, wherein a duration of advertisement comprises from 0 to 33 percent of a duration of the overall content stream.

12. The method of claim 2, wherein a duration of advertisement comprises from 34 to 66 percent of a duration of the overall content stream.

13. The method of claim 2, wherein a duration of advertisement comprises from 67 to 100 percent of a duration of the overall content stream.

14. The method of claim 2, wherein:
the mapping from one or more items to at least one advertisement includes a geographic location; and
matching an item in the viewer profile to one or more advertisements is also based on the geographic location and a location of the viewer.

15. The method of claim 2, further comprising:
storing the content of the advertisement in a storage device that is local to the viewer so that the content of the advertisement is retrieved without passing through the IP network if the advertisement is selected at a later time.

16. The method of claim 2, wherein retrieving the content of the advertisement comprises transferring the content of the advertisement from a storage device that is remote to the viewer through the IP network.

17. The method of claim 2, wherein:
the content of the advertisement is retrieved from a local storage device without passing through the IP network;
the content of the advertisement was retrieved from a remote storage device through the IP network based on a list of interested advertisements prior to retrieving the content stream; and
the list of interested advertisements was produced by matching items in the viewer profile to the advertisement profile.

18. The method of claim 2, wherein selecting the advertisement from the one or more advertisements is based on a length of the advertisement slot.

19. The method of claim 2, wherein selecting the advertisement from the one or more advertisements is based on how much an advertiser is willing to pay for having the advertisement inserted into the content stream, and wherein the advertisement profile includes a price that the advertiser is willing to pay for having the advertisement inserted into the content stream.

20. The method of claim 2, wherein selecting the advertisement from the one or more advertisements is based on a type of the content stream.

21. The method of claim 2, wherein selecting the advertisement from the one or more advertisements is based on a measurement of advertisement performance.

22. The method of claim 2, further comprising:
providing a user interface for the viewer to respond to the advertisement through a service available on the IP network.

23. The method of claim 2, further comprising:
providing an advertisement interface for an advertiser to modify the advertisement profile.

24. The method of claim 2, further comprising:
providing an advertisement interface for an advertiser to schedule an event and specify at least one item; and
modifying, when the event is triggered, the advertisement profile when the at least one item becomes available for sale.

25. The method of claim 2, further comprising:
updating the advertisement profile with advertisements from an advertising network.

26. The method of claim 2, further comprising:
matching, based on consultation with at least one advertisement network, an item in the viewer profile to one or more advertisements.

27. A device for supporting dynamic insertion of advertisements into a content stream delivered to a viewer through an Internet Protocol (“IP”) network, the device comprising:
a processor; and
a computer readable medium in communication with the processor, the computer readable medium having encoded thereon a set of instructions by the device to perform one or more operations, the set of instructions comprising:
instructions for maintaining a viewer profile that comprises at least one item of interest;
instructions for maintaining an advertisement profile that comprises a mapping from one or more items to at least one advertisement;
instructions for matching, based on the advertisement profile, an item in the viewer profile to one or more advertisements;
instructions for retrieving the content stream;
instructions for identifying, in the content stream, an advertisement slot into which an advertisement should be inserted;
instructions for selecting the advertisement from the one or more advertisements;
instructions for retrieving a content of the advertisement;
instructions for inserting the content of the advertisement into the advertisement slot in the content stream; and
instructions for causing a video component of the content stream with the content of the advertisement inserted to be displayed on a display device.

28. A system for supporting dynamic insertion of advertisements into a content stream delivered to a viewer through an Internet Protocol (“IP”) network, the system comprising:
a display device;
a storage device; and
a set top box configured to:
maintain a viewer profile that comprises at least one item of interest;
maintain an advertisement profile that comprises a mapping from one or more items to at least one advertisement;
match, based on the advertisement profile, an item in the viewer profile to one or more advertisements;
retrieve the content stream from the storage device;
identify, in the content stream, an advertisement slot into which an advertisement should be inserted;
select the advertisement from the one or more advertisements;
retrieve a content of the advertisement;
insert the content of the advertisement into the advertisement slot in the content stream; and
cause a video component of the content stream with the content of the advertisement inserted to be displayed on the display device.

29. A computer readable medium having encoded thereon a computer program comprising a set of instructions that are executable by a computer system to perform one or more operations to support dynamic insertion of advertisements into a content stream delivered to a viewer through an Internet Protocol (“IP”) network, the set of instructions comprising:
instructions for maintaining a viewer profile that comprises at least one item of interest;
instructions for maintaining an advertisement profile that comprises a mapping from one or more items to at least one advertisement;
instructions for matching, based on the advertisement profile, an item in the viewer profile to one or more advertisements;
instructions for retrieving the content stream;
instructions for identifying, in the content stream, an advertisement slot into which an advertisement should be inserted;
instructions for selecting the advertisement from the one or more advertisements;
instructions for retrieving a content of the advertisement;
instructions for inserting the content of the advertisement into the advertisement slot in the content stream; and
instructions for causing a video component of the content stream with the content of the advertisement inserted to be displayed on a display device.
